(19) United States
(12) Patent Application Publication
(10) Pub. No.: US 2023/0363355 A1
(43) Pub. Date: Nov. 16, 2023

(54) CANINE COLLAR LEG ATTACHMENT DEVICE

(71) Applicant: Patricia Muller, South Beloit, IL (US)

(72) Inventor: Patricia Muller, South Beloit, IL (US)

(21) Appl. No.: 17/744,174

(22) Filed: May 13, 2022

(51) Int. Cl. A01K 27/00; A45F 5/02

(52) U.S. Cl. CPC A01K 27/003; A45F 5/021; A45F 2200/05

(57) ABSTRACT

A canine collar leg attachment device for walking a canine hand free includes a strap positioned vertically against a leg of user. The strap has a top edge and a bottom edge, and the bottom edge is coupled to a d-ring. The top edge of the strap is coupled to a hook. A strip is positioned perpendicular relative to the strap and the strip enwraps the leg of the user. The strip has a first end and a second end, and the first end is attached to the d-ring of the strap. A cord is used to connect the strap to a canine collar. The cord has pair of ends. A pair of snaps is attached to a respective one of the pair of ends.

### CROSS-REFERENCE TO RELATED APPLICATIONS

Not Applicable

### (c) STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to canine leash device and more particularly pertains to a new canine leash device for walking a canine hand free.

### (2) DESCRIPTION OF RELATED ART INCLUDING INFORMATION DISCLOSED UNDER 37 CFR 1.97 AND 1.98

The prior art relates to canine leash devices. The prior art relates to variety of canine leash devices configured to facilitate the process of walking a canine. Furthermore, the prior art includes a variety of canine leash devices enwrapping a leg of a user with a plurality of straps. Known prior art lacks a canine leash device enwrapping the leg of the user with a single strap and coupled to a pant waist of the user by a bolt snap.

### BRIEF SUMMARY OF THE INVENTION

An embodiment of the disclosure meets the needs presented above by generally comprising a strap is configured for being positioned vertically against a leg of user. The strap has a top edge and a bottom edge. The bottom edge is coupled to a d-ring. The top edge of the strap is coupled to a hook. A strip is positioned perpendicular relative to the strap. The strip is configured for enwrapping the leg of the user. The strip has a first end and a second end. The first end is coupled to the d-ring of the strap. A cord is configured for coupling the strap to a canine collar. The cord has pair of ends. A pair of snaps is coupled to a respective one of the pair of ends.

Furthermore, a method for attaching a canine leash to a leg attachment device includes the step of securing a hook of a top edge of a strap to a belt loop of a pant waist of a user. The user enwraps a strap laterally around a leg of the user. A front surface of the strip fastens to a back surface of the strip by hook and loop fastening. Subsequently, the user secures a pair of snaps of a cord to a respective one of a d-ring of a bottom edge of the strap and a canine collar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a canine collar leg attachment device according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

### DETAILED DESCRIPTION OF THE INVENTION

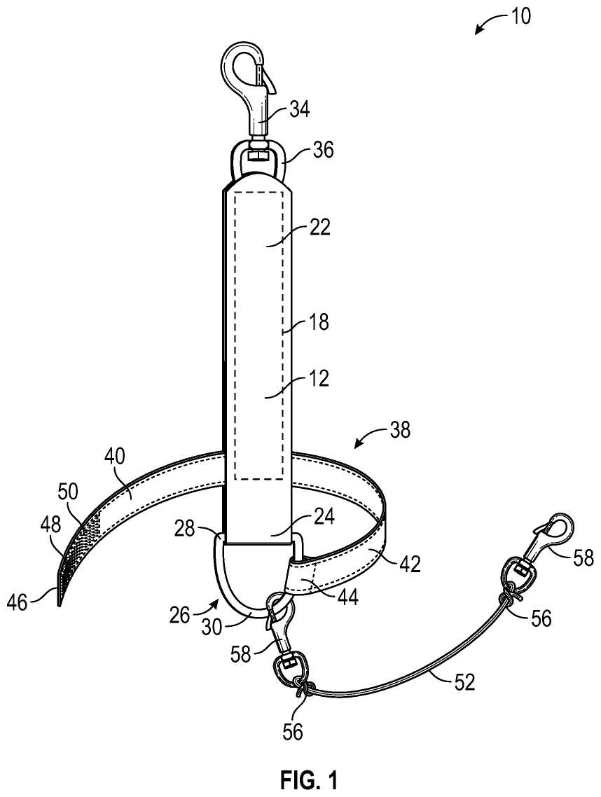

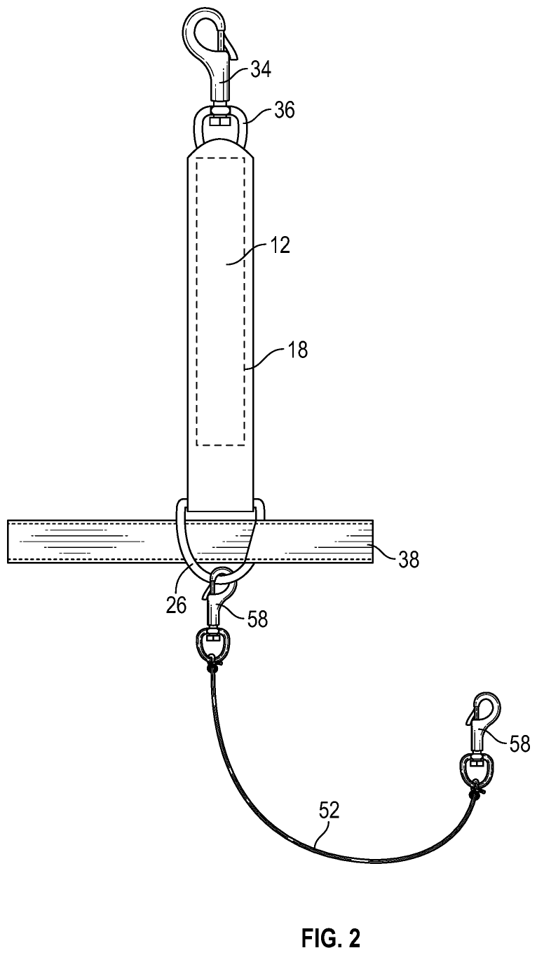

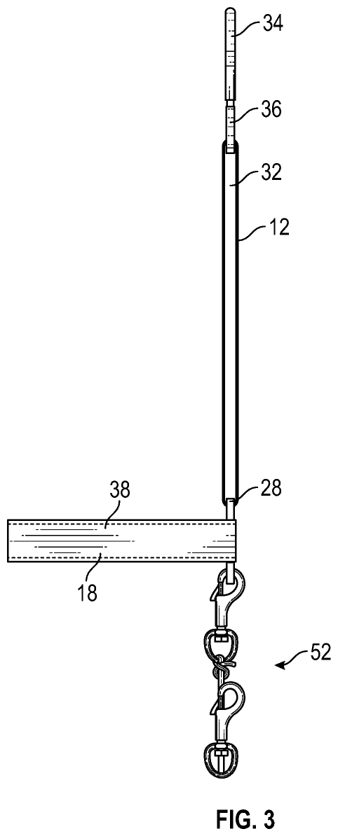

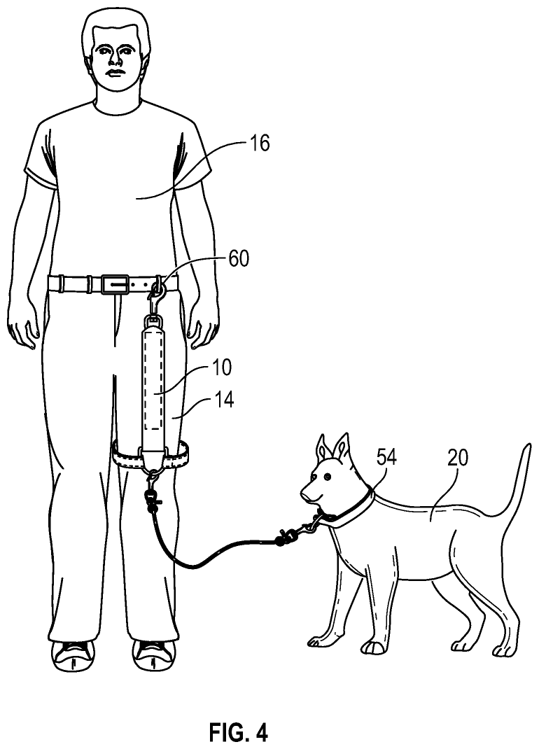

With reference now to the drawings, and in particular to FIGS. 1 through 4 thereof, a new canine leash device embodying the principles and concepts of an embodiment of the disclosure and generally designated by the reference numeral 10 will be described.

As best illustrated in FIGS. 1 through 4, the canine collar leg attachment device 10 generally comprises a strap 12 configured for being positioned vertically against a leg 14 of a user 16. The strap 12 has a tubular webbing 18 designed to provide enhanced reinforcement for the strap 12. The strap 12 is configured for being either a nylon material or a leather material.

Furthermore, the strap 12 has a top edge 22 and a bottom edge 24 being positioned parallel to each other. The bottom edge 24 is coupled to a d-ring 26. The B-ring 26 has a flat end 28 and a curved end 30, and the flat end 28 is positioned in an interior 32 of the strap 12 wherein retaining the d-ring 26 to the strap 12. The top edge 22 of the strap 12 is coupled to a hook 34. The hook 34 is a bolt snap. An end of the hook 34 has a ring 36 being positioned within the interior 32 of the strap 12 wherein retaining the hook 34 to the strap 12.

A strip 38 is positioned perpendicular relative to the strap 12. The strip 38 is configured for enwrapping the leg 14 of the user 16. The strip 38 has the tubular webbing 18 and is configured for being either the nylon material or the leather material like the strap 12. The strip 38 has a front surface 40 and a back surface 42. Additionally, the strip 38 has a first end 44 and a second end 46 with the first end 44 being coupled to the d-ring 26 of the strap 12. The curved end 30 of the d-ring 26 is positioned in an interior 32 of the first end 44 of the strip 38.

Furthermore, a hook material 48 is positioned proximate to the second end 46 on the front surface 40 of the strip 38. The hook material 48 is the first portion of hook and loop fastening. The front surface 40 of the second end 46 of the strip 38 has a loop material 50 being positioned adjacent to the hook material 48. The loop material 50 is complementary to the hook material 48 wherein the loop material 50 is the second portion of hook and loop fastening. The second end 46 of the strip 38 is configured for enwrapping the curved end 30 of the d-ring 26 and engaging by hook and loop fastening wherein enclosing the strip 38 in a circle around the leg 14 of the user 16.

A cord 52 is configured for coupled the strap 12 to a canine collar 54. The cord 52 is configured for being a nylon rope wherein being lightweight and flexible. The cord 52 has a pair of ends 56, and a pair of snaps 58 is coupled to a respective one of the pair of ends 56. Each of the ends 56 is coupled by a knot to a ring of each of the snaps 58. Each of the snaps 58 is configured for being the bolt snap, similar to the hook 34 of the top edge 22 of the strap 12.

In use, the user 16 secures the hook 34 of the top edge 22 of the strap 12 to a belt loop 60 of the pant waist of the user 16. The user 16 enwraps the strip 38 laterally around the leg 14 of the user 16. The second end 46 of the strip 38 fastens around the d-ring 26 of the strap 12 by hook and loop fastening. Subsequently, the user 16 secures the pair of snaps 58 of the cord 52 to a respective one of the d-ring 26 of the bottom edge 24 of the strap 12 and the canine collar 54. The user 16 and the canine 20 can proceed to move around while being tethered to each other.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A canine leash leg attachment device configured for enwrapping a leg of the user, the canine leash leg attachment device comprising:
a strap being configured for being positioned vertically against a leg of a user, said strap having a top edge and a bottom edge, said bottom edge being coupled to a d-ring, said top edge of said strap being coupled to a hook;
a strip being positioned perpendicular relative to said strap, said strip being configured for enwrapping the leg of the user, said strip having a first end and a second end, said first end being coupled to said d-ring of said strap; and
a cord being configured for coupling said strap to a canine collar, said cord having pair of ends, a pair of snaps being coupled to a respective one of said pair of ends.

2. The canine leash leg attachment device of claim 1, further comprising said strap having a tubular webbing, said strap being configured for being either a nylon material or a leather material.

3. The canine leash leg attachment device of claim 1, further comprising said top edge and said bottom edge being positioned parallel to each other.

4. The canine leash leg attachment device of claim 2, further comprising said d-ring having a flat end and a curved end, said flat end of said d-ring being positioned in an interior of said strap wherein retaining said d-ring to said strap.

5. The canine leash leg attachment device of claim 4, further comprising said hook being a bolt snap, and end of said hook having a ring being positioned within said interior of said strap, said ring of said hook being a swivel ring.

6. The canine leash leg attachment device of claim 2, further comprising said strip having said tubular webbing, said strip being configured for being either said nylon material or said leather material.

7. The canine leash leg attachment device of claim 1, further comprising said strip having a front surface and a back surface.

8. The canine leash leg attachment device of claim 4, further comprising said curved end of said d-ring being positioned within an interior of said first end of said strip.

9. The canine leash leg attachment device of claim 1, further comprising a hook material being positioned proximate to said second end on said front surface of said strip, a loop material being positioned adjacent to said hook material on said front surface of said second end said strip, said loop material being complementary to said hook material, said second end of said strip being configured for enwrapping said d-ring and engaging by hook and loop fastening wherein enclosing said strip in a circle.

10. The canine leash leg attachment device of claim 9, further comprising said second end of said strip being configured for engaging by hook and loop fastening to said first end of said strip wherein enclosing said strip in a circle.

11. The canine leash leg attachment device of claim 1, further comprising said cord being configured for being a nylon rope.

12. The canine leash leg attachment device of claim 5, further comprising each of said ends being coupled by a knot to an end of each of said snaps, each of said snaps being configured for being said bolt snap.

13. A canine leash leg attachment device configured for enwrapping a leg of the user, the canine leash leg attachment device comprising:
a strap being configured for being positioned vertically against a leg of a user, said strap having a tubular webbing, said strap being configured for being either a nylon material or a leather material, said strap having a top edge and a bottom edge, said top edge and said bottom edge being positioned parallel to each other, said bottom edge being coupled to a d-ring, said B-ring having a flat end and a curved end, said flat end of said d-ring being positioned in an interior of said strap wherein retaining said d-ring to said strap, said top edge of said strap being coupled to a hook, said hook being a bolt snap, and end of said hook having a ring being positioned within said interior of said strap, said ring of said hook being a swivel ring;
a strip being positioned perpendicular relative to said strap, said strip being configured for enwrapping the leg of the user, said strip having said tubular webbing, said strip being configured for being either said nylon material or said leather material, said strip having a front surface and a back surface, said strip having a first end and a second end, said first end being coupled to said d-ring of said strap, said curved end of said d-ring being positioned within an interior of said first end of said strip, a hook material being positioned proximate to said second end on said front surface of said strip, a loop material being positioned adjacent to said hook material on said front surface of said second end said strip, said loop material being complementary to said hook material, said second end of said strip being configured for enwrapping said d-ring and engaging by hook and loop fastening wherein enclosing said strip in a circle; and
a cord being configured for coupling said strap to a canine collar, said cord being configured for being a nylon rope, said cord having pair of ends, a pair of snaps being coupled to a respective one of said pair of ends, each of said ends being coupled by a knot to an end of each of said snaps, each of said snaps being configured for being said bolt snap.

14. A method for attaching a canine leash to a leg attachment device, the method including the step of:
securing a hook of a top edge of a strap to a belt loop of a pant waist of a user;
enwrapping a strip laterally around a leg of the user, a front surface of said strip fastening to a back surface of said strip by hook and loop fastening; and
securing a pair of snaps of a cord to a respective one of a d-ring of a bottom edge of said strap and a canine collar.
